(19) United States
(12) Patent Application Publication
(10) Pub. No.: US 2014/0359509 A1
(43) Pub. Date: Dec. 4, 2014

(54) Templates

(71) Applicant: Alp Sinan Baran, Ann Arbor, MI (US)

(72) Inventor: Alp Sinan Baran, Ann Arbor, MI (US)

(21) Appl. No.: 13/907,339

(22) Filed: May 31, 2013

(51) Int. Cl. G06F 3/0484; G06F 3/0481

(52) U.S. Cl. CPC G06F 3/0484; G06F 3/0481
USPC 715/771

(57) ABSTRACT

Among other things, a window is presented to a user through a user interface of an application running on a device. The window is for creating a template from which instances of documents will be generated. All of the documents that will be generated from the template include (a) at least one non-variable element that is part of the template, and (b) at least one value for a variable element that is part of the template, the value for the variable element depending on one or more selections made by the user in connection with document generation from the template. The user can enter the non-variable document element into the template creation window. A selection of types of variable elements is made available. When a user selects one of the types of a variable element, an interface element is presented in which the user can define the variable element in accordance with its type. The defined variable element is incorporated into the created template and into the window in which the template is being created. The created template is stored for use in generating the document instances.

### BACKGROUND

This description relates to templates.

Templates save time and effort in the creation of documents that share some elements in common and have other elements that differ from one document to another. We use the word “document” broadly to include, for example, any work product in any form, size, or medium that includes content expressed in any kind of elements and conveys information from a source or author of the document to a recipient or user of the document. We use the phrase “document elements” broadly to include, for example, any kind of element that can be included by an author or source in a document and that can express content, such as text, images, diagrams, sounds, and videos to name a few. We use the term “template” broadly to include any device that can represent a class of documents and express common elements that are shared by all of the documents of the class and custom elements that can be different for different documents of the class. We sometimes call a document that has been created using a template a “document instance of the template” or a “document instance of the class represented by the template.”

The creator of the template can include in the template the common elements (or information that describes them) and information about the custom elements, such as alternatives that can be selected for a custom element or a description of the nature of the custom element, or an indication that there is no restriction on the content of the custom element.

An author or source can create a document instance from a template by identifying or selecting or creating the custom elements. The document instance can then be, as we say, generated from the template and the custom information. The generated document instance can take any form, such electronic or paper, and be stored, used, and delivered in a variety of ways.

Templates have a wide variety of applications in a broad range of fields. As one example, in the medical field, doctors often choose to (or are required to) author documents in the form of reports of conversations with patients or physical examinations of patients or results of tests on patients. Reports often fall into classes, for example, reports on the conditions of skin lesions on patients of a dermatologist, and can be grouped to contain common elements. All of the reports within a class typically include some common elements (“I examined the patient's skin lesion that had been previously identified on” “located on” “having a size”) and some custom elements (“May 20, 2020” “anterior left forearm” “42 millimeters diameter”). It is convenient for reports of a given class to be authored by a doctor using a template associated with that class and an application running on a computer or a mobile device.

### SUMMARY

In general, in an aspect, a window is presented to a user through a user interface of an application running on a device. The window is for creating a template from which instances of documents will be generated. All of the documents that will be generated from the template include (a) at least one non-variable element that is part of the template, and (b) at least one value for a variable element that is part of the template, the value for the variable element depending on one or more selections made by the user in connection with document generation from the templage. The user can enter the non-variable element into the template creation window. A selection of types of variable elements is made available. When a user selects one of the types of variable elements, an interface element is presented in which the user can define the variable element in accordance with its type. The defined variable element is incorporated into the created template and into the window in which the template is being created. The created template is stored for use in generating the document instances.

Implementations may include one or any combination of two or more of the following features. The non-variable element includes text entered by the user. The variable elements that can be selected include at least one of a textbox variable, a single-select variable, a multi-select variable, a multi-select variable+And, a multi-select variable without And, a multi-select variable without And or Commas, a multi-select variable+negatives, and a multi-select dropdown. The interface presented to the user to enable the user to define the variable element in accordance with its type includes an interface element in which the user can type values of the variable element. The defined variable element is displayed in the window in which the template is being created as the name of the variable element, without displaying alternative available values for the variable element. The stored template includes the non-variable elements and the types and alternative values of the variable element. The information to be included in the template can be copied from information shown in another user interface presented in another window running on the device. The user can invoke the created template to cause it to generate an instance of the document using selections of the variable elements made by the user. The user includes a medical professional. The documents to be generated include medical reports. The variable elements are interleaved with the non-variable elements. Defining a variable element according to its type includes defining alternative values for the variable element and defining how the variable element is to appear or be treated in document instances generated from the template. The user can modify the template in the window and generate document instances from the modified template as soon as the template has been modified. The created template can be used and modified by other users.

In general, and an aspect, a window is presented to a user through a user interface of an application running on a device. A template can be created in the window from which instances of documents will be generated. All of the documents that will be generated include at least one non-variable document element that is part of the template and a value for a variable element that depends on a selection made by the user in connection with document generation from the template. The user can generate an instance of the document through a user interface of the same application including selecting possible values of variables as defined by the user in creating the template.

Implementations may include one or any combination of two or more of the following features. The user can modify the template in the window after generating the instance of the document, and user can generate another instance of the document through the user interface of the same application. The created template is stored, including information about the non-variable elements and the variable elements. The stored information is used by the user in generating the documents from the template. The template generates documents to be incorporated into medical reports. The user includes a medical professional.

These and other aspects, features, and implementations, and combinations of them, can be expressed as methods, apparatus, program products, systems, components, business methods, means and steps for performing functions, and in other ways.

These and other aspects, features, implementations, and advantages will become apparent from the following description and from the claims.

### DESCRIPTION

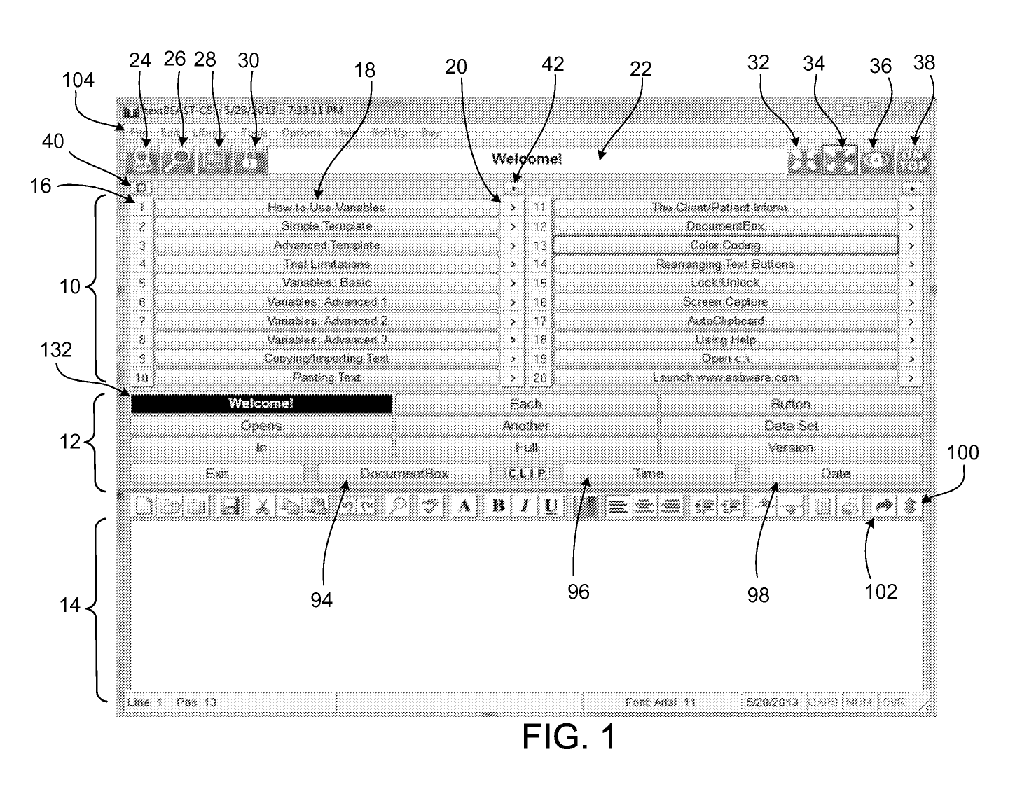

FIGS. 1 through 15 are screen.

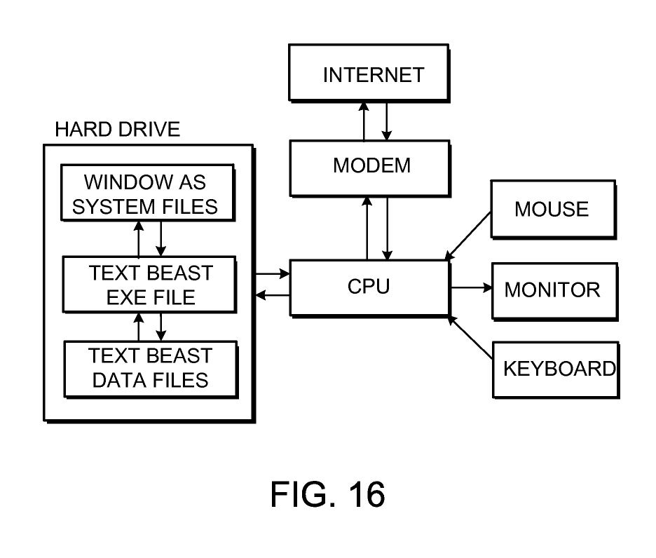

FIG. 16 is a block diagram.

Here we describe a simple, easy-to-use. easy-to-understand, effective way to create templates that can be used to generate documents. We also describe how the created templates can be used easily by an author or source to generate the documents. In some implementations, the templates are created and the documents are generated from the templates using a software application running on a computer or on a handheld device. We sometimes refer to implementations of the techniques as a system or an application, for simplicity. The documents that are generated from a template in the system can be generated in a wide variety of forms and generated in a wide variety of ways. For example, a document instance can be generated as simple text that can be pasted into any text editor, word processor or electronic medical record, providing a universal tool to help professionals automate their documentation. The application speeds the process of generating documents or writing reports by allowing a user to build menu-driven templates from which meaningful documents can be generated. Some implementations of the application can run on a computer directly from a USB drive, without installation of any files onto the computer, increasing its portability of the system. We use the term menu-driven templates broadly to include, for example, templates that include any technique or device that provides alternatives or guidance or pre-arranged content that can be selected for inclusion as custom elements in a document instance to be generated from the template.

Electronic medical record (EMR) software packages sometimes include a component that enables limited simple template creation by specialized technical staff on a custom time-consuming basis.
In contrast, the application and system that we describe allows users to create easily, simply, repeatedly, at any time or place and without any computer programming knowledge, custom templates that include user-defined variables and can then be used easily to generate automated medical reports, for example. Because of the ease with which templates can be created and the ability of almost anyone to create them, many useful templates can be created for every conceivable need. We use the phrase user-defined variables broadly to include, for example, the identification of any kinds of elements that are to be part of the generated documents and the content of which are determined at the time of document generation based on variable definitions provided by the creator of the template and selections of instances of each variable by a document author or source when using the template.
In working with a created template in the system prior to executing the template to generate a document instance, each of the variables is presented to the author in a menu (or other similar selection control or device) of selectable items (we sometimes call them values of the variable), such as symptoms in a list, which when selected will be included in sentences formed by the system in the generation of the document instance. Several different variable types and additional features allow flexible conversion of a series of menu selections into meaningful narrative text. This allows document automation (that is, the generation of large number of documents easily and at least partly automatically) that speeds the process of medical reports and progress notes, and can be quickly created and modified by the user. In the templates during editing (we sometimes refer to the process of working with a created template to get it ready for generating a document instance), each variable is displayed alone and in red text within blue double brackets to identify it as a variable rather than as a common element that will appear in all documents generated from the template. The alternative available values of the variable are kept hidden for ease of reading and use until a mouse click is performed over the variable, to reveal the alternative available values within the same interface that was used to create the variable. A wide variety of other devices and combinations of them can be used to display the template variables to an author, to enable the author to view possible values of the variables, and to enable the author to select values.

When the application is launched, its features are presented to a user through windows or panels of a compact easy-to-understand easy-to-use user interface. A user can easily navigate through various windows to perform all of the functions provided by the application, including creation of templates, configuring a created template in preparation for document generation, generation of a document instance from the template, and use of the generated document instance in a variety of ways. The features of the application could be exposed to a user in a wide variety of other user interface devices and combinations of them. In some implementations, features for template creation could be separated from features for document generation from templates, in two different applications. Templates that have been created by one user can be shared with other users who can then easily generate document instances from them.

The Text Container Buttons, the Template Editor Window, and the DocumentBox deserve some general introductory comments before detailed descriptions, for clarity. The Template Editor Window is used to create or edit templates that are stored in association with the Text Container Buttons. Clicking a Text Container Button opens the Template Editor Window and loads it with any text that the storage associated with the Text Container Button may already contain. Any text entered into the Template Editor Window is saved in the active Text Container Button. The active Text Container Button is indicated by green color of the adjacent Copy and Paste Buttons. The Text Container Button that is active can be changed at any time by clicking a different Text Container Button to make that button active. The upper textbox of the Text Editor Window then becomes the visible title of the Text Container Button, and the larger lower textbox contains the template, which also can be previewed by hovering the mouse over the Paste Button, when the Template Editor is closed. The DocumentBox is a rich textbox that can be shown or hidden, featuring simple but effective word processing functions. When showing, it is the target of any text pasted by clicking the Paste Buttons and is used to assemble and edit documents. Also, any highlighted text within the DocumentBox can be copied into the Text Container Button when an adjacent Copy Button is clicked.

Referring to FIG. 1, in some implementations, the application window has three key sections: the three sections respectively expose to the user Text Container Buttons 10, Page Buttons 12, and a DocumentBox 14. Each Page Button opens a different set of Text Container Buttons. In some implementations, each Page Button corresponds to a set of twenty Text Container Buttons. Each Text Container Button 18 is a pointer to a text or a template of the user. When the user invokes a Page Button, a window showing the corresponding Text Container Buttons is displayed. When a user invokes a Text Container Button, the Template Editor window opens to display the corresponding text or template. Each Text Container Button is accompanied by a Copy Button 16 on the left and a Paste Button 20 on the right. When the user invokes the Copy Button, text selected or highlighted in the DocumentBox or another Windows application running on the computer or device is imported into the Text Container Button; this is intended as a convenient way of importing text into the application, as a starting point for template generation. When the user invokes the Paste Button, the text or template in the Text Container Button is pasted into the DocumentBox (if showing) or if the DocumentBox is hidden, into another Windows application that was in focus before the button was clicked. The DocumentBox, when showing, is the default target for all text output resulting from clicking the Paste Buttons and is used to generate/edit text. All text and all templates of a user are organized by the system in a database, stored as a Data file for that user. Each Data file contains Libraries; in some implementations of the application, there are ten Libraries, but there could be more or fewer than ten. Each Library contains Page Buttons; in some implementations of the application, there are nine Page Buttons, but there could be more or fewer than nine. Each Page contains Text Container Buttons; in some implementations of the application, there are twenty Text Container Buttons, but there could be more or fewer than twenty. The Page Button fields in the database are used to populate the Page Buttons in the user interface. The Text Container Buttons fields in the database are used to populate the Text Container Buttons in the user interface.

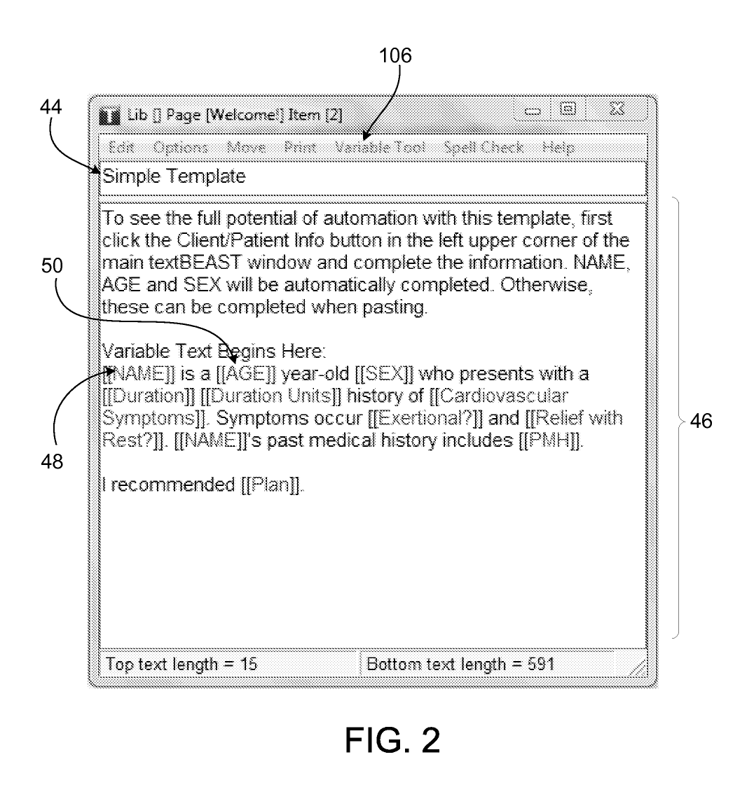

The Text Container Buttons are an important feature to enable the user to navigate and to perform important functions of the application such as: coping, pasting, and editing text and templates in the Template Editor Window. Clicking a Text Container Button brings up the Template Editor Window, FIG. 2, which allows the user to compose and edit templates. Invoking the Copy Button copies into the Text Container any text that has been selected or highlighted in other windows or the DocumentBox, if it is open. If CTRL is pressed while clicking the Copy Button, the text is added or appended to the existing text in the Text Container, instead of replacing it. Invoking the Paste Button pastes all text in the Text Container into another window (the one last one in focus or clicked) or the DocumentBox, if it is open. If text contains variables, the possible values of each of the variables are presented for selection before the final text is pasted.

Invoking each of the Page Buttons enables the user to navigate to a different data set, or pages. In some implementations of the application, each page contains a separate set of twenty Text Container Buttons, and there are nine Page Buttons in each of ten Libraries, so that each data file stored by the system contains 10 Libraries×9 Pages×20 Text Containers=1800 fields for user data.

In some examples of the system, the DocumentBox is a rich text box presented in the lower portion of the user interface, and is used during the generation of documents from the templates or otherwise to assemble documents. The DocumentBox can be opened and closed using the button labeled DocumentBox 94. When the DocumentBox is closed, if a paste function is invoked, the text operated on by the paste function is pasted directly into the most recent window clicked outside of the application. For example, if a word processing application is open on the computer or device and was the last window in focus before the Paste Button was clicked, text within the corresponding Text Container Button will be pasted at the cursor position within the word processor. The size of the DocumentBox can be adjusted. The DocumentBox has its own toolbar 100 that provides functions to edit text and manage text files, including common word processing command buttons. In some implementations, available functions include file commands, edit commands, undo/redo, find text, spell check, font formatting, justification, indentation, headers and footers, and printing. The application also supports exporting the content of the DocumentBox using a toolbar button 102. The size of the DocumentBox can be maximized using a toggle button 100 on the far right of the DocumentBox toolbar. The same button can be clicked again to restore the original size.

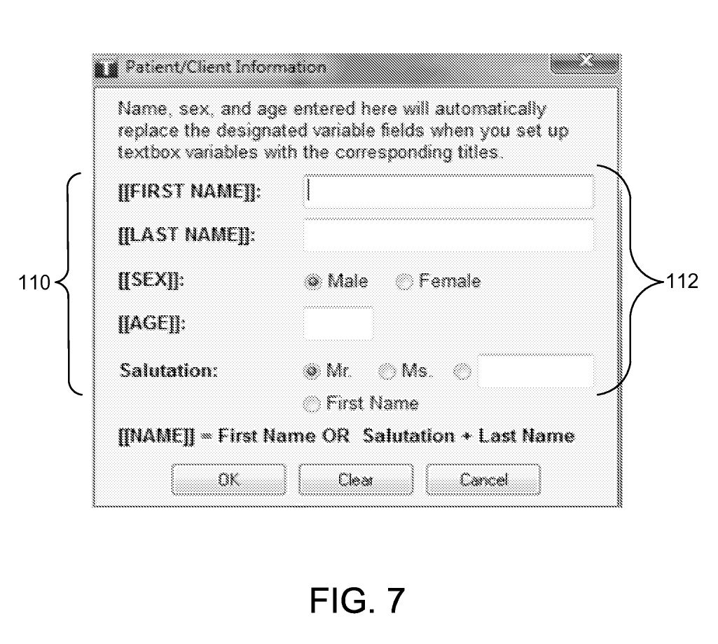

The Patient/Client Information Window, FIG. 7, is accessed through button 24 of the application's main window, and provides easy access to pre-defined variables 110 related to basic patient information (for example, [[FIRST NAME]], [[LAST NAME]], [[SEX]], [[AGE]]). Once patient information is entered by the user in fields 112, substitution of the current values will occur automatically whenever the pre-defined variables are present in a template that is invoked by clicking the Paste Button.

The Find/Replace Window, accessed by the user invoking button 26, can be used to search and replace text in the current page, library, or file. There is a separate Find/Replace function for the DocumentBox.

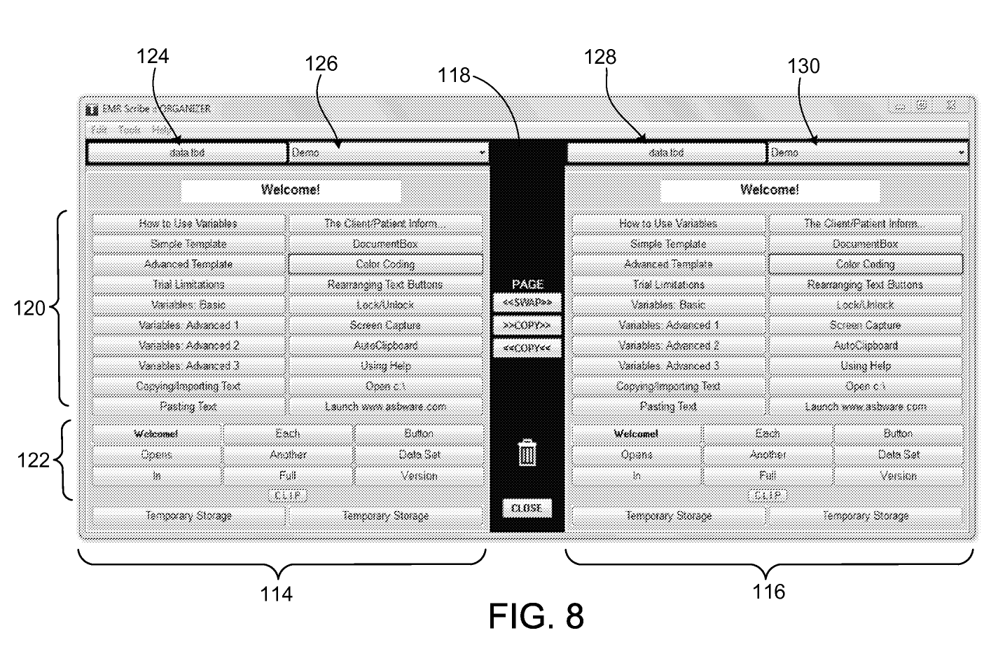

The Organizer Window, FIG. 8, is accessed through button 28 of the application's main window and enables management of the application's database structure. The Organizer Window is arranged into two panes, 114 and 116, and provides swap/copy/delete functions 118 for pages and drag/drop editing of Text Container Buttons across the databases represented by the two panes. The Organizer Window allows file selections using buttons 124 and 128 for management within the same file or across two different data files, and across any two Libraries 126 and 130 within the same or different data files. Pages 122 may be copied or swapped. Text Container Buttons 120 within a page can be reorganized by the drag and drop method, and the “Temporary Storage” locations can be utilized during the process, if needed, before drag and dropping Text Container Buttons into the final desired locations.

The Lock/Unlock Button 30 of the main application window locks and unlocks the Text Container Buttons and the Title of the current Page Button to prevent unintended editing. With the lock in effect, the Copy buttons will not function, but Paste, manual copying (right mouse menu or ctrl+c), and drag and drop functions remain functional. With the lock in effect, if the user attempts to perform a function that is not allowed, the lock/unlock button will blink, alternating between red and the current button color, as a reminder of the locked status.

When the application is running and the main application page of FIG. 1 is open, there is a page of the user's work that is active and to which actions and views of the user relate. The Page Title for the active page is displayed in text field 22. If the user enters a new Page Title in the field, the active Page Button (black background with white text, giving a pressed button appearance) will automatically take the same name. Similarly, if the user enters a new title into active Page Button, the Page Title will automatically take the same name. The application provides the user with image capture functions represented by image capture buttons 32 and 34. The user may capture an image of the last active window by clicking on button 32 or the entire screen by clicking on button 34. Both actions provide an opportunity for the user to crop the image before saving it. Saved screen captures may be viewed later via the View Screen Captures Button 36.

The On Top button, 38, configures the application window to remain on top of all other windows that are displayed on the user's screen, even when the user is working on another window. Other always-on-top windows will be ignored when pasting directly into other Windows applications by clicking the Paste Buttons while the DocumentBox is hidden. To paste into other always-on-top windows (an unusual scenario), the user must use manual targeting, activated by clicking the “Manual Targeting: Turn On” item on the Tools menu.

Although the figures that we have discussed show windows displayed by the system or application for creating templates and generating documents from them, in typical (but not necessarily all) uses of the system the application is only one of two or more running on the computer and user interface window of the application is only one window that appears on the screen. The source of information and content elements that are to be included in the generated document can be text entered into the system itself or can be taken instead from another application running on the computer or from another window on the screen. Similarly, the document generated by the system can be placed into document windows of other applications on the desktop and used in them for the creation of more comprehensive documents, notes, or files, for example.

For instance, another application running on a computer may be displaying a digital image of a skin lesion of the patient taken by an image capture device. All or a portion of that image can be captured on the screen and put into a document that is being generated from a template in the system. That document instance may contain text describing the lesion and naming the patient by identification number. That document instance can then be copied and pasted into an electronic patient file that includes a long chronological sequence of notes and images.

Thus buttons 34 and 36 can be used for capturing all or part of the screen for inclusion in a document. The On Top button 38 will keep the application on top relative to the windows of other applications running on the computer. Other functions and features of the system are designed to work seamlessly with other applications running simultaneously.

Compact/Full Size button 40 switches the application between two window sizes. When using the application for general-purpose clipboard operations, a more compact size can be convenient. The user can adjust each size to suit the user's needs, and these sizes will be saved automatically when the user switches between them. Right-clicking the button cycles through different options for information displayed on the Title Bar.

The MultiPaste button 42 sequentially pastes the contents of all 10 Text Container Buttons below it into the target document. If a Text Container Button contains variables, options for values of the variables, for example, will be presented to the user for configuration, after the MultiPaste button is pushed but before the final text is pasted. Right-clicking the MultiPaste button sequentially pastes each variable contained within Text Container Buttons without any items selected. This can be used to insert default text (for example, indicating no abnormalities on a physical examination) if each item is set up accordingly with the Advanced Option: Insert If None Checked on the Variable Tool of the Template Window. The user also has the option of inserting tab, space, carriage return and various characters between the pasted items. If any Text Container Buttons contain web addresses or folder/file paths, these will be pasted as text. MultiPaste can also be used to automatically complete web forms by adding a tab between entries to move the insertion point to the next field. MultiPaste can also be used to paste Text Container Button contents into spreadsheet cells in a row or column by selecting the corresponding option.

Copy/Import button 16 enables copying text into only the adjacent Text Container Box 18, from selected text in the DocumentBox or another application. Left clicking replaces the Text Container contents with the new text. Ctrl+Left Click adds the new text to the end of the existing content. Right Click replaces the label of the Text Container Box without changing the context of the Text Container itself.

Paste button 20 enables pasting text from only the adjacent Text Container Button 18 into the DocumentBox or another application. Left click pastes text within the Text Container Button to the DocumentBox (if open) or target window in another application. Ctrl+Left Click pastes only the label of the button. Right Click sends tab commands to the DocumentBox or target window. Middle mouse button click (if available) sends an enter/carriage return command. If the adjacent Text Container Button contains variables, options will be presented after the Paste button is clicked, but before the final text is pasted.

Left clicking Time and Date, 96 and 98, pastes the current time or date into the DocumentBox or target application. Right clicking Time sends a tab command. Right clicking Date sends a carriage return/enter command.

The main window menu items 104 provide access to common application functions. For example the user may create a new data file, save the current one, or open an existing one. The user may select which Library among those in the data file the user wishes to use.

The Template Editor, FIG. 2, is the heart of the application. Within this textbox, the user can set up highly sophisticated templates with built-in variables to speed up the user's documentation. Although the Template Editor behaves as a typical textbox when typing into it, variables can be inserted using the Variable Tool 106, which is a graphical user interface to create and modify variables. Using the Variable Tool, the user can easily insert 7 different variable types into a template. These variables will be translated into easily selectable options presented during document generation invoked by clicking the Paste Button adjacent to a Text Container Button. Variables appear within the template as red text enclosed within blue double brackets ([[example]]) and with a click of the mouse over the variable, can be easily edited and/or converted to different variable types by again displaying the Variable Tool graphical user interface.

When pasting a Text Container Button's template with variables, each variable type presents the user with different capabilities to customize the final text.
1. The Textbox Variable presents a textbox that the user types into. This is useful for names and other information that is difficult to predict with multiple-choice options.
2. The Single-Select Variable presents options from which only one can be selected (option buttons).
3. The Multi-Select Variable+And presents options from which one or more can be selected, and in the generated text, these are separated by commas, with an “and” before the last item. This is useful for completing a sentence with a list of items, such as symptoms (e.g., The patient complains of A, B, C, and D).
4. The Multi-Select Variable without And presents options from which one or more can be selected, and these are separated by commas, without an “and” before the last item.
5. The Multi-Select Variable without And or Commas presents options from which one or more can be selected, and these are not separated by commas. This is used when each option is a complete sentence.
6. The Multi-Select Variable+Negatives is the same as the Multi-Select Variable+And variable, with the added feature of automatically listing all unselected items as “pertinent negatives” (e.g., The patient reports A, B, and C. The patient denies D and E.
7. The Multi-Select Dropdown results in a list of items separated by commas. Typing the first letters of an option auto-completes the option. If the desired item is not present in the available dropdown list, it can be typed in, and will be added to the list of options for future use.

The Variable Tool Menu's Custom Words option allows the user to specify the words used for “and” (for use in The Multi-Select Variable+And and The Multi-Select Variable+Negatives), “reports” (for the selected values in the Multi-Select Variable+Negatives), and “denies” (for the unselected values in the Multi-Select Variable+Negatives) inserted by the appropriate variable types in case the user's language is not English.

Once created, variables can be modified using the same interface, which will appear when the user clicks on any of the variables.

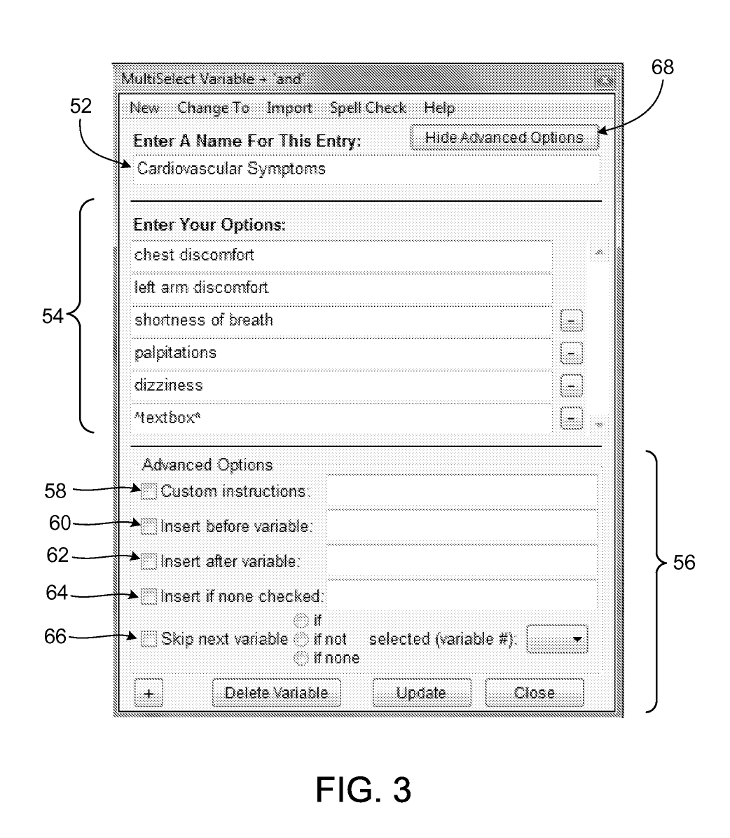

An example Variable creation window is shown in FIG. 3. The Variable Name 52 is provided by the user and will appear in the user's template as [[Variable Name]]. Variables may be named however the user wishes. A variable can be used multiple times within a template but all instances of the same variable will be updated identically after the user makes a selection on the first instance. Options 54 is where the user creating the variable enters the options that will be presented when the template is pasted and the variable needs to be resolved. The user may also enter ̂textbox̂, which will present a textbox for that item at the time the template is pasted and the variable needs to be resolved. The user may also enter ̂linê, which will draw a separating line at that location to allow visual grouping of items presented, for ease of use at the time the template is pasted and the variable needs to be resolved. The user may also add a variable within a variable (nested variable), designating such with double pointed brackets around nested variable and specifying the variable type based on the divider character used. The Variable Tool can also create the nested variables in advance, by right-clicking the Insert button; this pastes the correctly formatted nested variable in the DocumentBox, for copying and pasting into one of the options for the final variable.

Several additional advanced options are available when creating or modifying a variable. Any text entered into the Custom Instructions box 58 will appear as a heading for the variable when the template is run, helping to guide the user in making a selection. In some cases, the user may want make variables more self-contained by specifying text that will come before/after any selected options. Any text typed into the Insert Before Variable and Insert After Variable textboxes, 60 and 62, will serve that purpose. For example, the text “The patient reported”, commonly used to precede any symptoms selected, could be entered into the Insert Before Variable option instead of leaving the text in the template itself—allowing a more self-contained and versatile variable, which can be skipped entirely if desired during document generation, without any fragments of incomplete text remaining in the final document. Text entered into Insert if None Checked textbox 64 will be inserted if no “multiple choice” options are selected.

In some cases, a variable may only be appropriate depending on a selection of the preceding variable. For example, if a symptom list includes “chest pain” among a list of other cardiovascular symptoms, the user may want to follow it with a variable describing the chest pain, but only if chest pain was selected from the first variable. In such a case, the user would use the Skip Next Variable checkbox 66, then the “if not selected” option, then using the drop down menu select the number corresponding to the “chest pain” item (when an item number is selected, the actual item listed in the upper section of the window will flash yellow, making confirmation of the correct selection easier). Similarly, there may be cases where the user wants to skip the following variable if a certain item is selected, or if none of the items is selected. “If” and “if none” options are available for such cases.

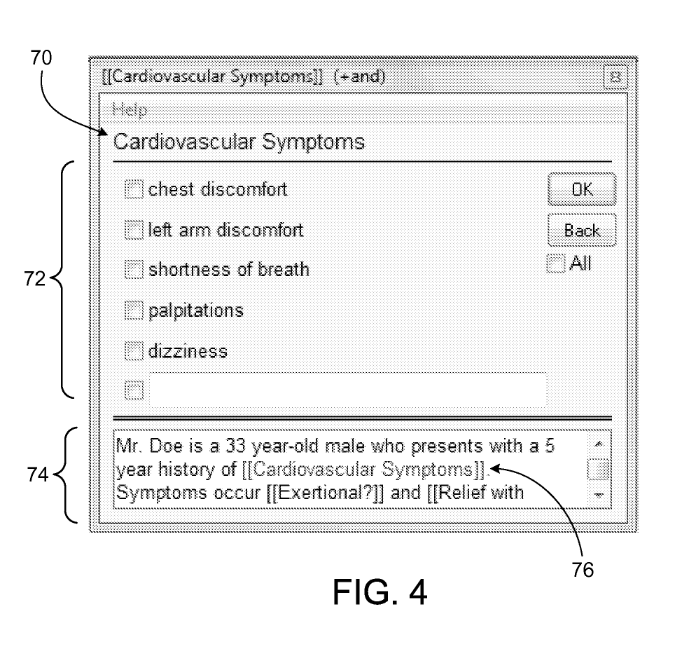

FIG. 4 illustrates how variable options, configured as shown in FIG. 3, are presented to a user at the time the template containing the variable is pasted into the DocumentBox or target application. When invoking/executing the template containing the variable 70, the user will be presented with a dialog box, allowing selection of options 72 that were created. Note that an option containing the text “̂textbox̂” becomes a textbox, into which the user can enter any text that he/she wishes to add to the options during execution. Textbox 74 displays the present status of the template text, with previously resolved variables converted to final text and variables not yet resolved appearing as the variable name within double brackets. Highlighted variable 76 (appears in red text in the running application) indicates which variable among the variables in the template is currently being resolved through selection of options 72.

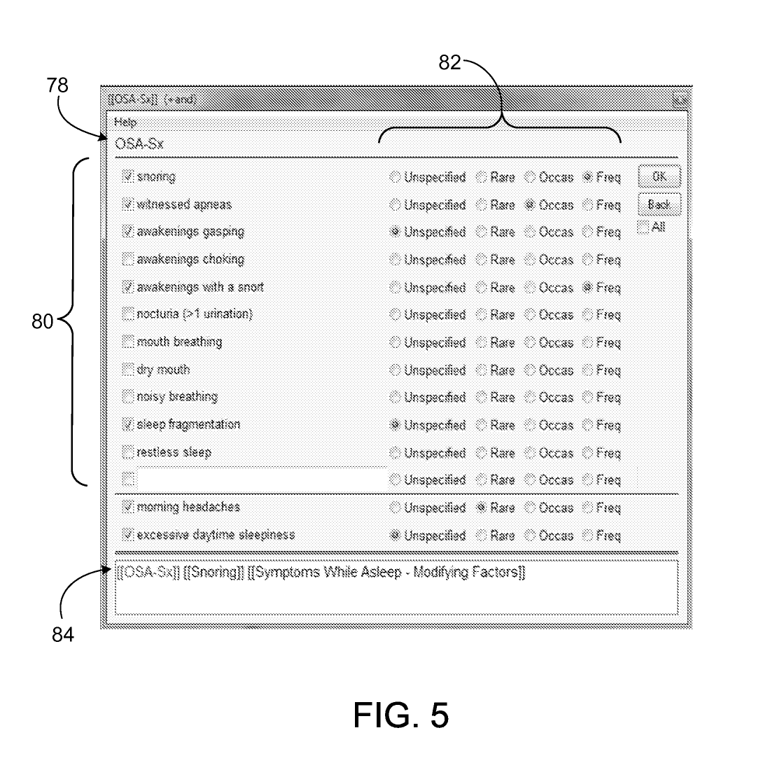

Previously illustrated are the design and resolution of a multi-select variable, representing design variable types 3, 4, 5, and 6. See FIGS. 3 and 5. Below are illustrated the remaining variable types.

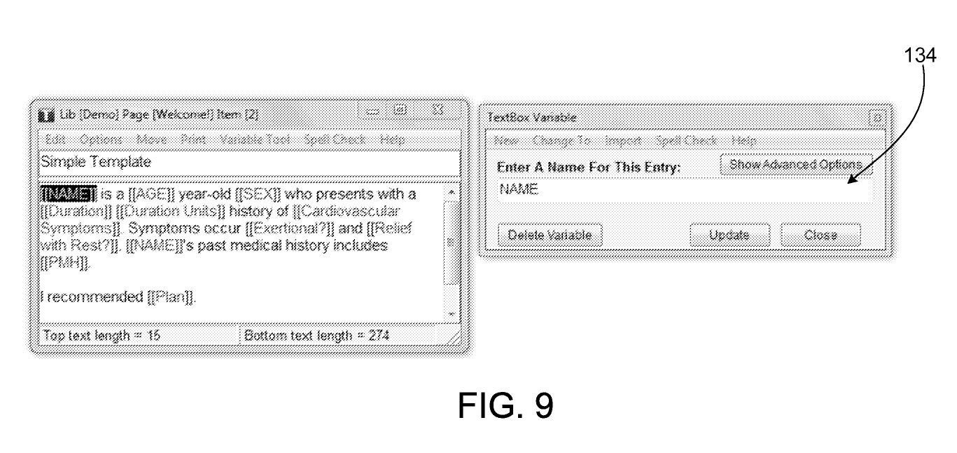

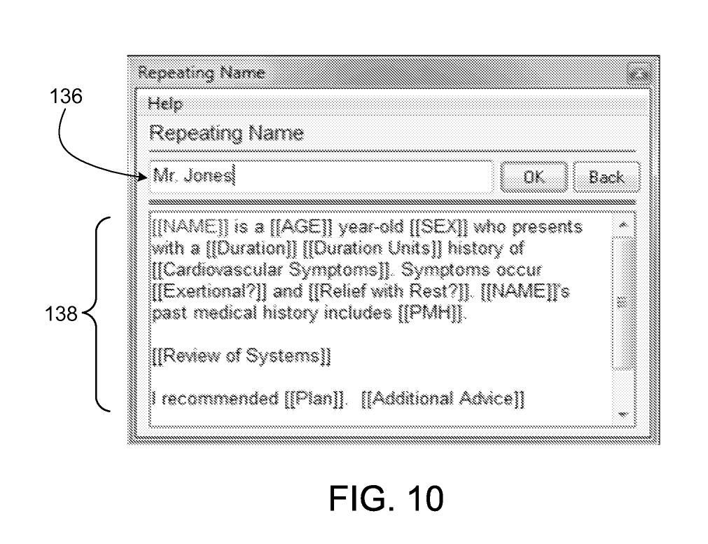

The Textbox Variable is the simplest variable type, requiring no configuration during variable design other than the Variable Name 134. See FIG. 9. Instead the variable allows the user, at the time of variable resolution, to enter text 136 that will be inserted into the designated location(s) in the template. See FIG. 10. The same variable can be used multiple times in a template, and every instance will be updated at once when the first instance is completed. Referring again to FIG. 10, entry of text “Mr. Jones” by the user means that when templated text 138 completed resolution, “Mr. Jones” will be substituted in place of [[NAME]].

The application supports easy display of symptom frequency. Referring to FIG. 5, when a Variable Name 84 is used in a template with the suffix “-Sx”, the resolution interface displayed to the user at the time of variable resolution includes frequency options 82 for each symptom option 80. This allows the user to state the frequency of symptoms, if desired. The resulting sentence includes the selected items with frequency included or unspecified, depending on the selections made.

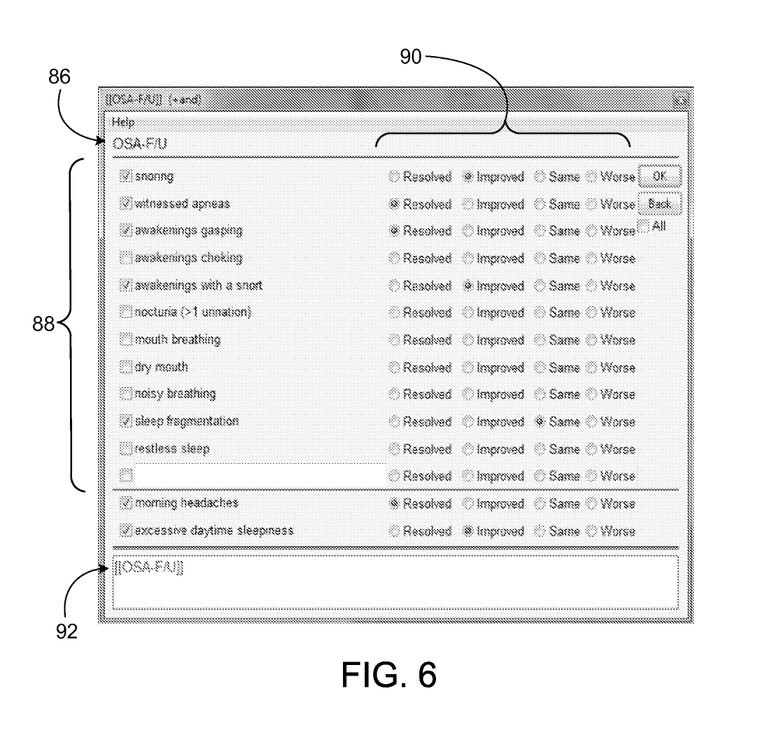

The application also supports easy display of follow-up status. Referring to FIG. 6, when a Variable Name 92 is used in a template with the suffix “-F/U”, the resolution interface displayed to the user at the time of variable resolution includes follow-up options 90 for each symptom option 88. This allows the user to easily document the status of symptoms for follow-up visits. Once the variable is resolved, the final text will group symptoms based on their follow-up status.

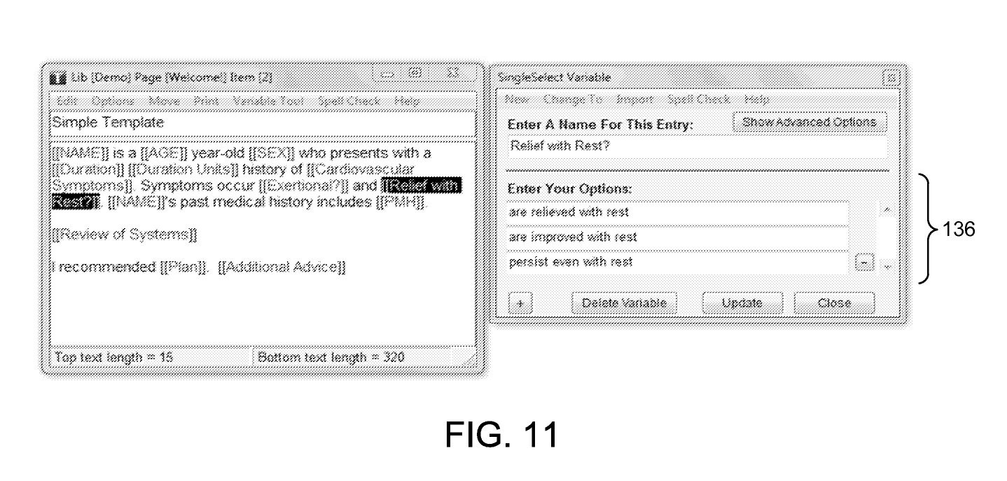

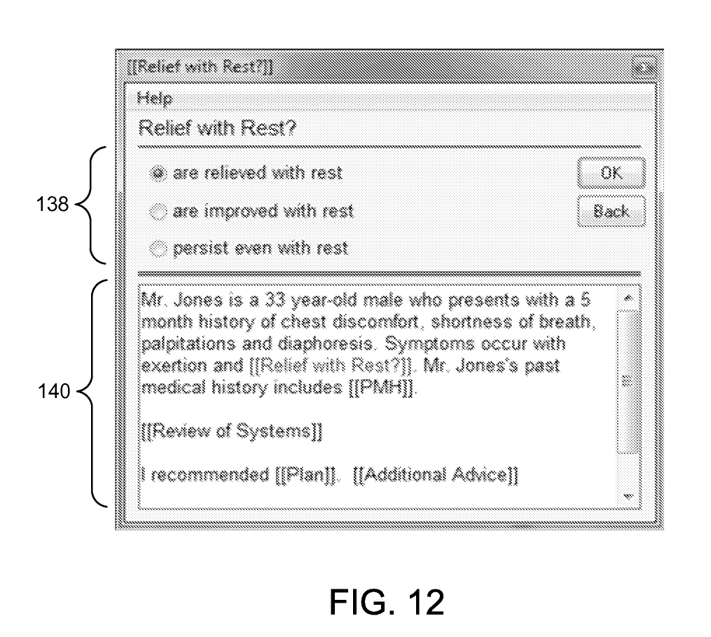

The Single Select Variable forces the selection of only one item. Referring to FIG. 11, the user at design time enters the list of options 136 for the variable, similar to design of the multi-select variable types. Referring to FIG. 12, during resolution the user is able to select only a single option 138 among those created during variable design. Referring still to FIG. 12, selection of “are relieved with rest” option will result in the substitution of that text in place of the variable [[Relief with Rest?]] when template 140 is fully resolved.

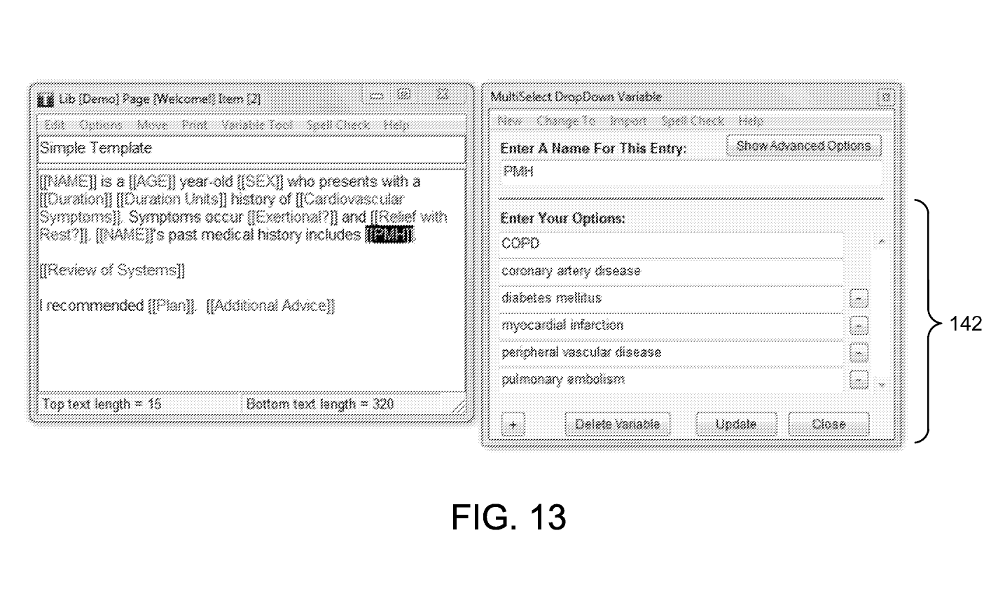

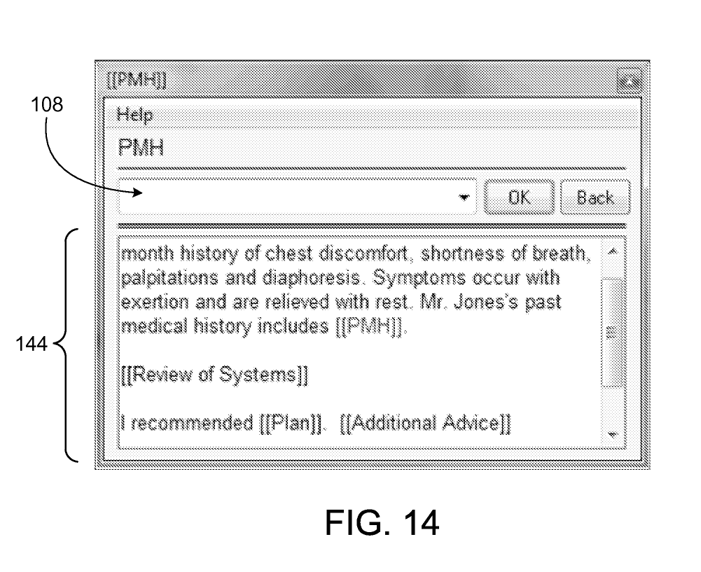

The Dropdown Variable allows selection of one or more items and is best suited for long lists of options that would otherwise not fit into a list of checkboxes or option buttons. Referring to FIG. 13, the design of a Dropdown Variable is similar to that of the single select or multi-select variables, where multiple options 142 are created at the time of variable creation. But, referring to FIG. 14, during resolution the user is presented with a combobox 108 instead of a list of options. The user may click the combobox to view the list of selectable options 142. In the alternative, if the user begins to enter text into combobox 108, the application will auto-fill the entry based on matching the entered letters with the available options. After each selection followed by clicking the “OK” button, the user has the option to complete the process by pressing the “Done” button, or continue adding items. The “OK” button temporarily becomes the “Done” button after each selection, and is reset back to “OK” if another dropdown selection is made. Referring still to FIG. 14, when variable resolution is complete [[PMH]] will be replaced with a comma-separated list of all options selected from or auto-filled by the combobox.

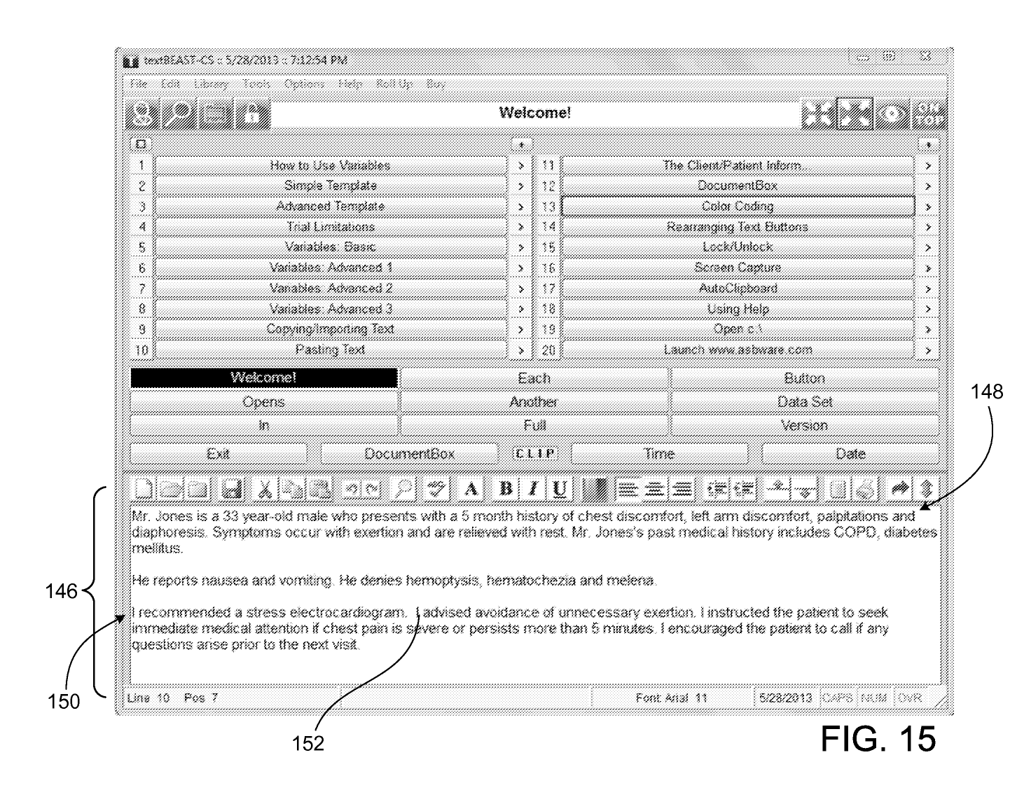

FIG. 15 illustrates the final result after the variable resolution sequence is completed. The template, illustrated in FIGS. 9, 11, and 13, contained variables of various types represented by red text enclosed by blue double-brackets. After final resolution, DocumentBox 146 contains the templated text once all variables have been replaced by the options selected or text entered during variable resolution. For example, [[NAME]] has been replaced by “Mr. Jones”, [[AGE]] by 33. Furthermore, self-contained variables such as [[Cardiovascular Symptoms]], [[Plan]], and [[Additional Advice]] have been replaced with full descriptions of the patient's symptoms 148, recommended course of action 150, and additional advice 152 given to the patient.

The techniques described here can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described here can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

Some of these hardware and software elements are illustrated in FIG. 16.

The examples for illustration only and not to limit the alternatives in any way. The techniques described can be performed in a different order and achieve useful results.

Other implementations are within the scope of the following claims.

1. A method comprising
presenting to a user through a user interface of an application running on a device, a window in which to create a template from which instances of documents will be generated,
all of the documents that will be generated from the template including at (a) least one non-variable element that is part of the template, and (b) at least one value for a variable element that is part of the template, the value for the variable element depending on one or more selections made by the user in connection with document generation from the template,
enabling the user to enter the non-variable element into the template creation window,
making available a selection of types of variable elements,
when a user selects one of the types of variable elements, presenting an interface element in which the user can define the variable element in accordance with its type,
incorporating the defined variable element into the created template and into the window in which the template is being created, and
storing the created template for use in generating the document instances.

2. The method of claim 1 in which the non-variable element comprises text entered by the user.

3. The method of claim 1 in which the variable elements that can be selected include at least one of a textbox variable, a single-select variable, a multi-select variable, a multi-select variable+And, a multi-select variable without And, a multi-select variable without And or Commas, a multi-select variable+negatives, and a multi-select dropdown.

4. The method of claim 1 in which presenting an interface element in which the user can define the variable element in accordance with its type comprises an interface element in which the user can type values of the variable element.

5. The method of claim 1 in which the defined variable element is displayed in the window in which the template is being created as the name of the variable element and without displaying alternative available values for the variable element.

6. The method of claim 1 in which the stored template includes the non-variable element and the types and alternative values of the variable element.

7. The method of claim 1 in which information to be included in the template can be copied from information shown in another user interface presented in another window running on the device.

8. The method of claim 1 comprising
enabling the user to invoke the created template to cause it to generate an instance of the document using selections of the variable elements made by the user.

9. The method of claim 1 in which the user comprises a medical professional.

10. The method of claim 1 in which the documents to be generated comprise medical reports.

11. The method of claim 1 in which the 1 in which the variable elements are interleaved with the non-variable elements.

12. The method of claim 1 in which defining a variable element according to its type includes defining alternative values for the variable element and defining how the variable element is to appear or be treated in document instances generated from the template.

13. The method of claim 1 comprising enabling the user to modify the template in the window and to generate document instances from the modified template as soon as the template has been modified.

14. The method of claim 1 comprising enabling the created template to be used and modified by other users.

15. A method comprising
presenting to a user through a user interface of an application running on a device, a window in which to create a template from which instances of documents will be generated, all of the documents that will be generated including at least one non-variable document element that is part of the template and a value for a variable element that depends on a selection made by the user in connection with document generation from the template, and
enabling the user to generate an instance of the document through a user interface of the same application including selecting possible values of variables as defined by the user in creating the template.

16. The method of claim 15 comprising
enabling the user to modify the template in the window after generating the instance of the document, and
enabling the user to generate another instance of the document through the user interface of the same application.

17. The method of claim 15 comprising storing the created template including information about the non-variable elements and the variable elements and using the stored information and information provided by the user in generating the documents from the template.

18. The method of claim 15 in which the template generates documents to be incorporated into medical reports.

19. The method of claim 15 in which the user comprises a medical professional.

20. A method comprising
presenting an author with a text editing application in which the author can create a document from at least one template, where the at least one template can also be created within the text editing application.

21. The method of claim 20 in which the at least one template is created in advance of document creation and is saved in a database for later use.

22. The method of claim 20 in which the templates saved in the database are presented to the author.

23. A method comprising
presenting a creator of a template with a text editor used to define the template, where the template may be composed of common text, variables, or a combination of the two.

24. The method of claim 23 in which the creator is presented with a list of at least one variable type supported by the template.

25. The method of 24 in which selecting a variable type from the list presents the template creator with an interface for defining a variable of the selected variable type.

26. The method of claim 25 in which the interface allows the creator to describe at least one possible value for the variable.

27. The method of claim 26 in which the possible value for the variable is a nested variable.

28. The method of claim 27 in which the interface allows the creator to name the variable.

29. The method of claim 27 in which a second variable may be skipped depending on the value of a first variable.

30. The method of claim 23 in which the creator is presented with a list of at least one pre-defined variable for use in the template.
